(19) United States
(12) Patent Application Publication
(10) Pub. No.: US 2002/0158448 A1
(43) Pub. Date: Oct. 31, 2002

(54) Modern automotive cockpit

(76) Inventor: Chidiebele Okonkwo, Atlanta, GA (US)

Correspondence Address: CHIDIEBELE OKONKWO, 670 McGILL PLACE, ATLANTA, GA, 30312, US

(21) Appl. No.: 09/841,920

(22) Filed: Apr. 26, 2001

(51) Int. Cl. B60R 21/16

(52) U.S. Cl. 280/728.2; 296/37.12

(57) ABSTRACT

This is a conceptual automotive cockpit designed for application to several vehicles. The steering wheel has been flattened at the top and bottom to enhance the beauty of the design. The turn signal switches, headlight switches and high beams have all been modified into buttons located on the central display. The windshield wiper and washer have been modified into a knob located to the left side of the steering wheel. The meters and gauges have been divided into three separate displays located around the steering wheel. A coin box has been provided for storing small items. This coin box is operated by a magnetic mechanism, which is disengaged when the box is pushed inwards slightly. Once returned to the closed position, the coin box is held in place again by the magnet. The parking brake release lever is located beneath the coin box, to eliminate the need for a lever commonly found along the central console area. There is a G.P.S. (global positioning system) screen placed at the top of the central display. Several buttons are provided to control it. The C.D. player, radio system and A.C./heating controls have all been incorporated into this display. The extended central console area houses an automatic transmission gear, a small storage case for cellular phones, the movable pad, the concealed cup holders and a center console box. The front passengers panel section houses an airbag, an extending board for writing upon, penholders and the glove box.

### BACKGROUND OF THE INVENTION.

1. Field of Invention:

This interior cockpit is for automotive vehicles. It consists of modified forms and features that are both innovative and unique. This cockpit can be applied to sedans, sports coupes or sports utility vehicles. The intent of the design is to present the public with a new interactive environment.

2. History of Prior Art:

It is now common for automotive firms to assign the development of concept vehicles to teams within the research and development departments or portfolio studios. The interior design and components play a critical role in the vehicles eventual marketability. Most conceptual cockpits consist of regular elements found in vehicles already in production, but in a modified fashion. This cockpit is an attempt to replace several existing elements, and enhance their appeal and functions. Since the marketability of a vehicle largely depends on its appeal to the consumers, it seems necessary to produce a cockpit which provides constant interaction and comfort to its passengers.

### BRIEF SUMMARY OF THE INVENTION.

Within this cockpit design, new switches have been provided for the headlights, windshield wipers, and turn signals. The power windows and door locks for the driver and front passenger have been incorporated into a movable pad which is similar in design to control pads for video game consoles. The fuel filler lid, hood release lever, and trunk release lever are all operated using buttons located above the movable pad. An extending board has been supplied to provide support for reading or writing in the front passenger's position. Two penholders have been incorporated onto the extending board, for holding pens or pencils. A Global Positioning System (G.P.S) screen has been added to the top central portion of the panel. The steering wheel has been flattened at the top and bottom portions in order to enhance the beauty of the cockpit. A parking brake release lever has been placed beneath the driver's coin box. The cup holders are concealed within a compartment located in front of the center console box. There are two ignitions located behind the steering wheel, one on the left side and the other on the right side. This is provided for the driver's convenience and preference. The instrument panel has been divided into three separate displays.

### BRIEF DESCRIPTIONS OF THE DRAWINGS.

FIG. 1 is the perspective view of the entire console, showing all the components that are described in detail through the other diagrams.

FIG. 2 is a perspective view of the driver's panel section, showing the features that have been installed there.

FIG. 3 is a perspective view of the central display of the cockpit.

FIG. 4 is another perspective view of the central display of the cockpit.

FIG. 5 is a perspective view of the driver's panel section showing the new windshield washer and wiper knob.

FIG. 6 is a perspective view of the new turn signal switches and the new headlight and high beam buttons.

FIG. 7 is a perspective view of the new turn signal switches and the new head light buttons, while being operated.

FIG. 8 is a side view of the windshield wiper knob.

FIG. 9 is a side view of the windshield wiper knob while it is depressed (to activate the washer).

FIG. 10 is a front view of the top meter display. This houses the speedometers and the tachometer.

FIG. 11 is a front view of the left meter display. This houses the fuel gauge and engine coolant temperature gauge.

FIG. 12 is a front view of the central meter display. This houses most of the warning and indicator lights.

FIG. 13 is a perspective view of the front passenger's panel section, showing the features that have been installed there.

FIG. 14 is a perspective view of the front passenger's panel section, showing the extending board after it has been pulled outwards.

FIG. 15 is a perspective view of the front passenger's panel section, showing the glove box opened.

FIG. 16 is a perspective view of the extended central console area showing the movable pad, mobile phone case, several buttons, the automatic gear, the cup holders (concealed), map storage cases and central console box.

FIG. 17 is a perspective view of the extended central console area showing the movable pad in its alternate position, the cup holders revealed and the central console box opened.

FIG. 18 is a side view of the extended central console area showing the movable pad in its alternate position, the cup holders revealed and the central console box opened. The selector button and overdrive button are also shown.

FIG. 19 is a perspective view of the central console area showing the C.D. player and FM/AM controls.

FIG. 20 is a perspective view of the inside mirror, which is divided into two parts.

FIG. 21 is a side view of the inside mirror.

FIG. 22 is a side view of the inside mirror, at an alternate position.

### DETAILED DESCRIPTION.

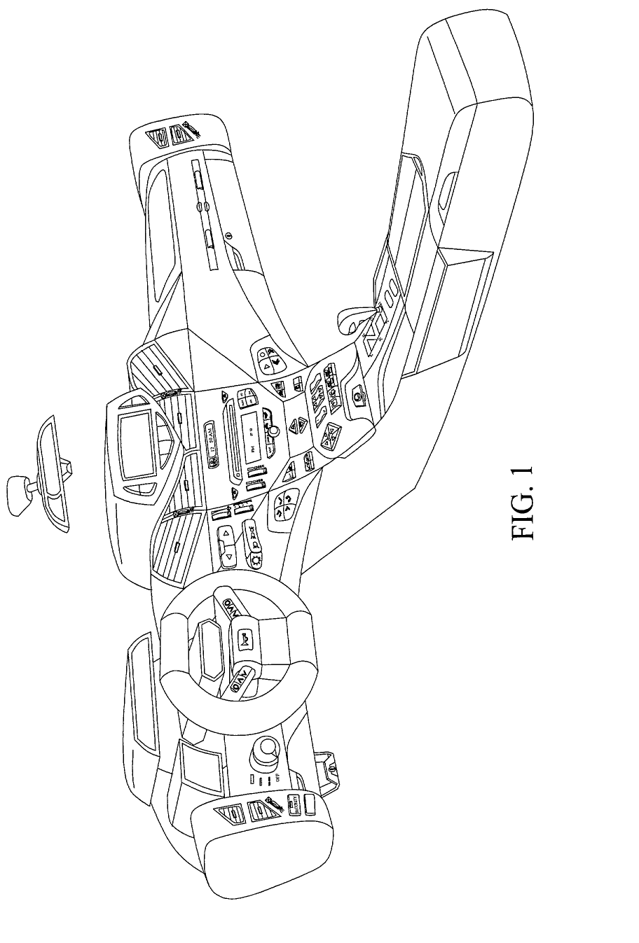

FIG. 1 shows the entire cockpit 100, in accordance with the invention.

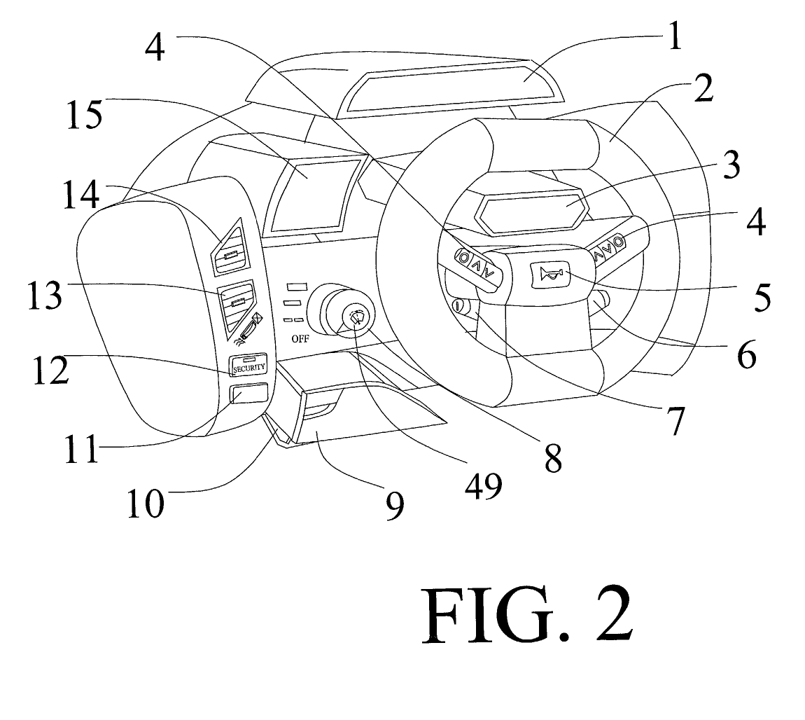

In FIG. 2, the windshield wiper 8 and washer 49 have been modified into a knob located beneath the left meter display 15. The windshield wiper knob 8 is moved to the desired position to operate the wipers. The windshield washer 8 is activated by depressing the entire knob 8.

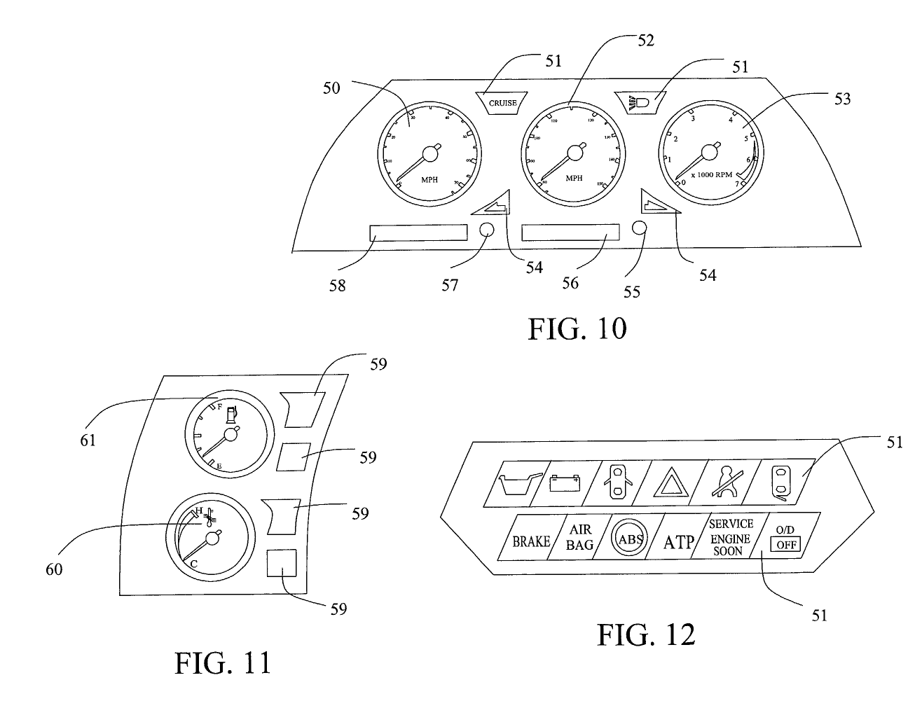

The top meter display 1 is placed above the steering wheel 2. The top meter display 1 houses the two speedometers and the odometer, along with several indicator lights (these are described in FIG. 10). The central meter display 3 is placed above the central portion of the steering wheel 2. The central meter display 3 houses several warning and indicator lights (these are described in FIG. 11). The left meter display 15 houses the fuel gauge, engine coolant temperature gauge and several other buttons (these features are described in FIG. 12). There are two ignitions, the left ignition 7 and the right ignition 6, each provided for the drivers preference and convenience. The horn 5 is located at the center of the steering wheel 2.

The cruise control buttons 4 are placed on the right and left sides of the steering wheel. The circular button activates the cruise control, and sets it at the vehicles current speed. The button pointing upwards increases the speed, while the button pointing downwards decreases it. The circular button is also for deactivating the cruise controls. The coin box 9 is shown open and is located beneath the windshield washer knob 8. The coin box 9 is held in the closed position by a magnetic mechanism, which is disengaged when the coin box 9 is slightly pushed inwards. It is activated again when the coin box 9 is closed. The air vents, 13 and 14, are shown to the right of the driver's console area. An extra button 11 is provided beneath the security indicator light 12. The parking brake release lever 10, has been covered by the opened coin box 9.

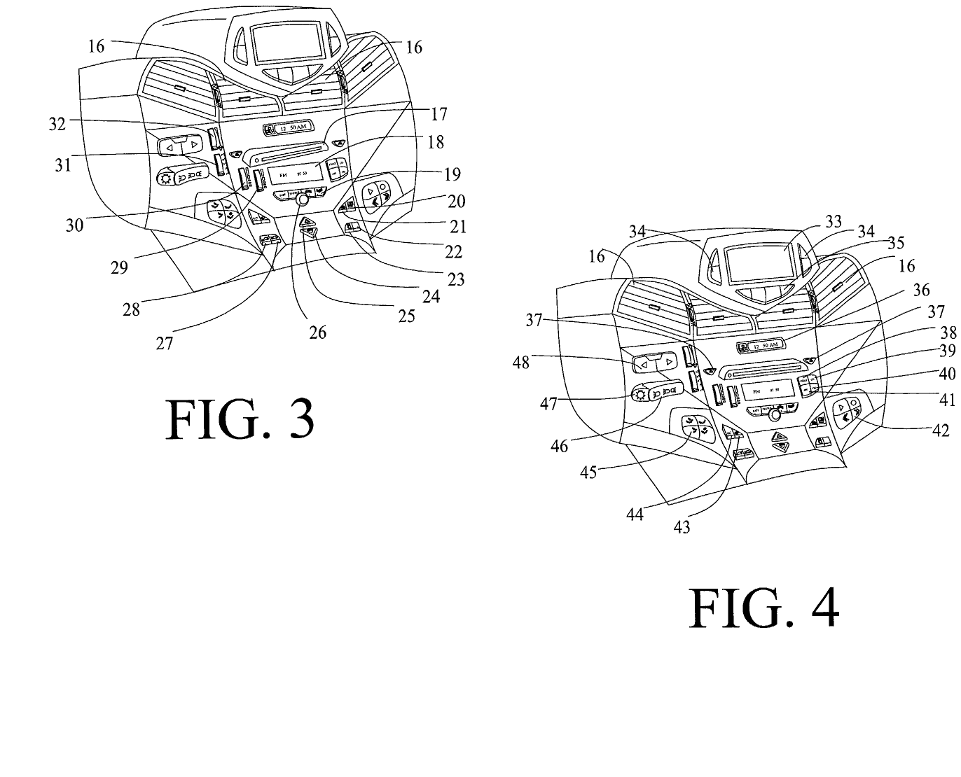

In FIG. 3, the C.D. player 17 is shown beneath the air vents 16. The C.D. Player 17 can be tilted slightly to the left side or the right side. It is shown tilted to the right. The L.C.D display 18 shows the radio station and the selected band. It also shows the time left and number of the current track when a compact disc is being played. The button cluster 19 beneath the L.C.D. display 18 is for selecting the radio station, and controlling the bass and treble.

The rear defogger button 20 is located beside the air recirculation button 21. There is an extra button 22 placed beside the fuel filler release button 23. The movable pad activation button 24 is used to raise or lower the movable pad 83 (shown in FIG.17). The hazard button 25 is used for emergency situations. The volume control button 26 is located beneath the button cluster 19. When depressed, the volume control button 26 turns on (or turns off) the C.D. player 17 and radio. The heat temperature dial 29 is placed beside the A.C. temperature dial 30. The fan control dial 31 is located beneath the instrument brightness control dial 32.

In FIG. 4, the central console display is shown along with several buttons. The Global positioning system (G.P.S) screen 33 is placed above the air vents 16. There are several buttons, 34 and 35, for controlling the G.P.S. The clock 36 is placed beneath the air vents 16. On the clock 36, the circular button is for selecting the time or period of the day (am or pm). The button with an increasing arrow raises the selected feature. The button with the decreasing arrow reduces the selected feature. The circular button is then pressed a second time in order to set the adjusted time. There are two C.D. player eject buttons 37. One is closer to the driver the other is closer to the front passenger.

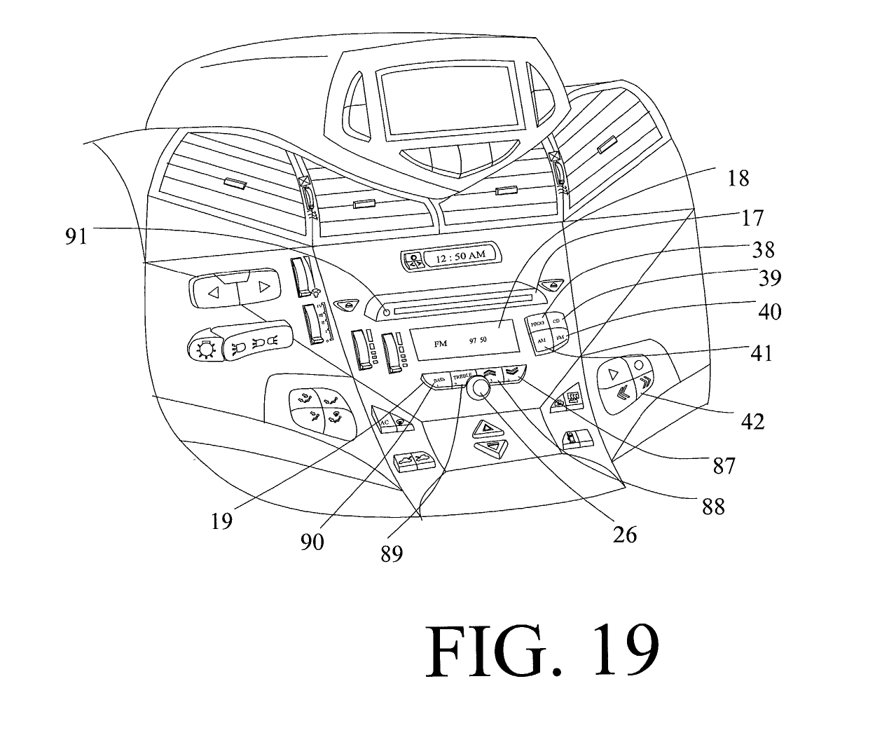

There is a button cluster beneath the left C.D. player eject button 37. This cluster consists of the program button 38, C.D. player button 39 and FM 41 and AM 40 buttons. The program button 38 is used for setting the chosen radio station. The C.D. player button 39 is used for activating the C.D. player 17. The AM 41 and FM 40 buttons are used for selecting the desired radio station (these are further described in FIG. 19). The C.D. player control buttons 42 are placed together in a cluster. The A.C. button 44 is located beside the heat button 43. The airflow control buttons 45 are located beneath the head light button 46. Above the head light button 46 and the high beam button 47 is the turn signal button 48.

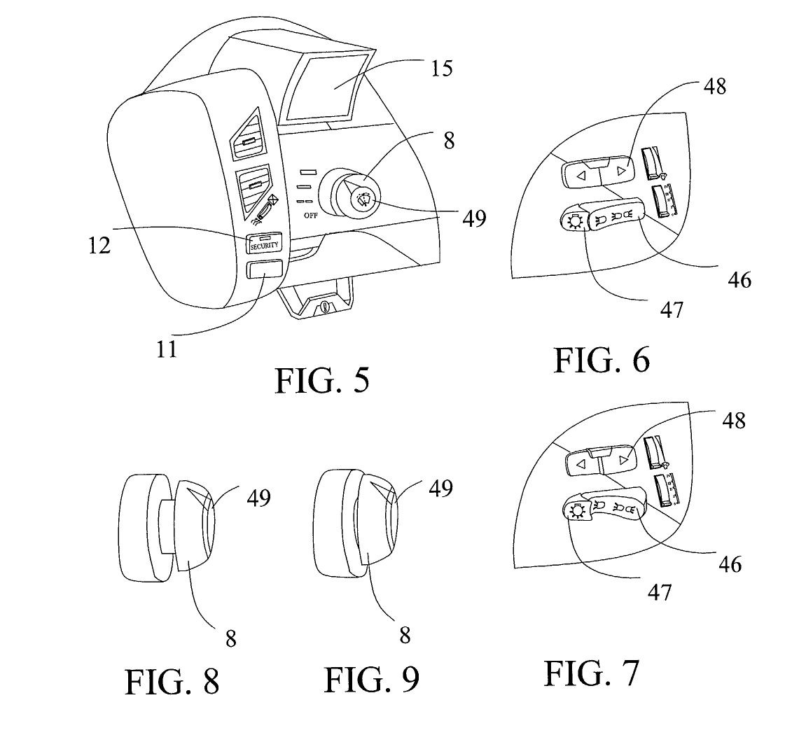

In FIG. 5, the windshield wiper 8 and washer 49 knob is shown. The security indicator light 12 and an extra button 11 are also shown.

In FIG. 6, the turn signal buttons 48 and the headlights 46 and high beam 47 buttons are shown.

In FIG. 7, the head light button 46 is depressed. It operates like a regular switch, but has two levels to which it can be depressed. The first position is when the lights are turned off completely (as illustrated by FIG. 6). In the second position, the low beams are turned on. In the third position, the headlights are fully turned on. Depressing the high beam button 47 activates the high beams. It operates independently from the headlight button 46. The turn signal button 48 is also shown depressed. When the central portion of the turn signal buttons 48 is depressed, both turn signals flash simultaneously.

In FIG. 8, the windshield washer 8 and wiper 49 are shown.

In FIG. 9, the windshield washer 49 is activated by depressing the knob 8. This would also cause the wipers to wipe the windshield several times, automatically.

In FIG. 10, the top meter display is shown. This houses the two speedometers 50 and 52, and the tachometer 53, along with the turn signal indicator lights 54 and other indicator lights 51. When the maximum speed (75 mph) is reached in the first speedometer 50, the second speedometer 52 then begins to read the vehicles speed (starting from 76 mph). The odometer 58 and its reset button 57 are located beneath the first speedometer 50. The trip odometer 56 and its reset button 55 are separate and are beneath the second speedometer 52.

In FIG. 11, the left meter display is shown. Here, the fuel gauge 60 and engine coolant temperature gauge 61 are located. There are also several extra indicator lights 59 for extra features that may be exclusive to a certain vehicle model.

In FIG. 12, the central meter display is shown. This houses several standard warning and indicator lights 51.

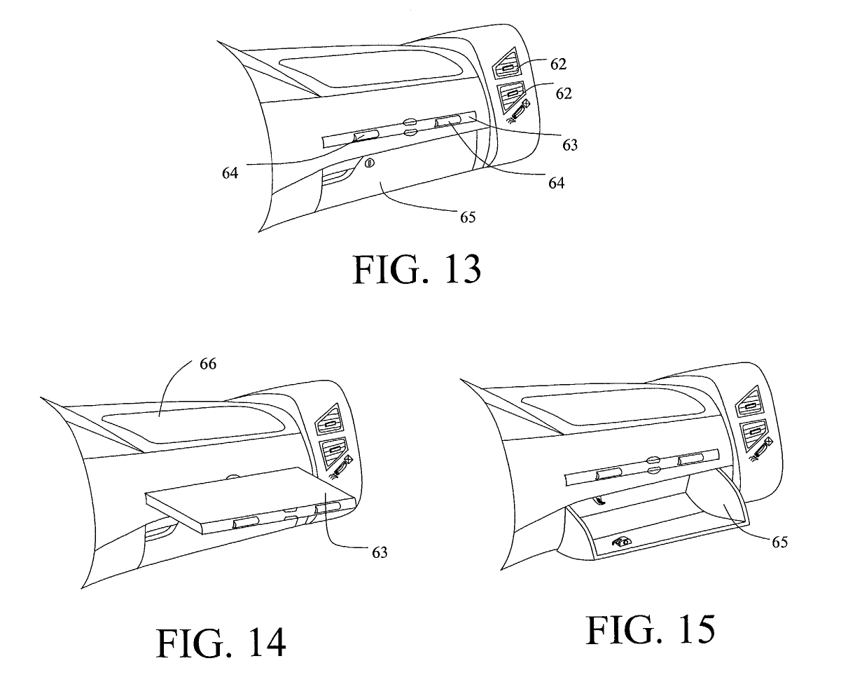

In FIG. 13, the front passenger's console area is shown. The right air vent 62 is divided into two segments. The extending board 63 is shown in its concealed position. The penholders 64 have been placed on the extending board 63. The glove box 65 is closed.

In FIG. 14, the extending board 63 has been pulled out. This is done manually, and it is also returned to the concealed position manually. The front passenger's air bag 66 is located above the extending board 63.

In FIG. 15, the glove box 65 has been opened. It can be locked to protect important documents.

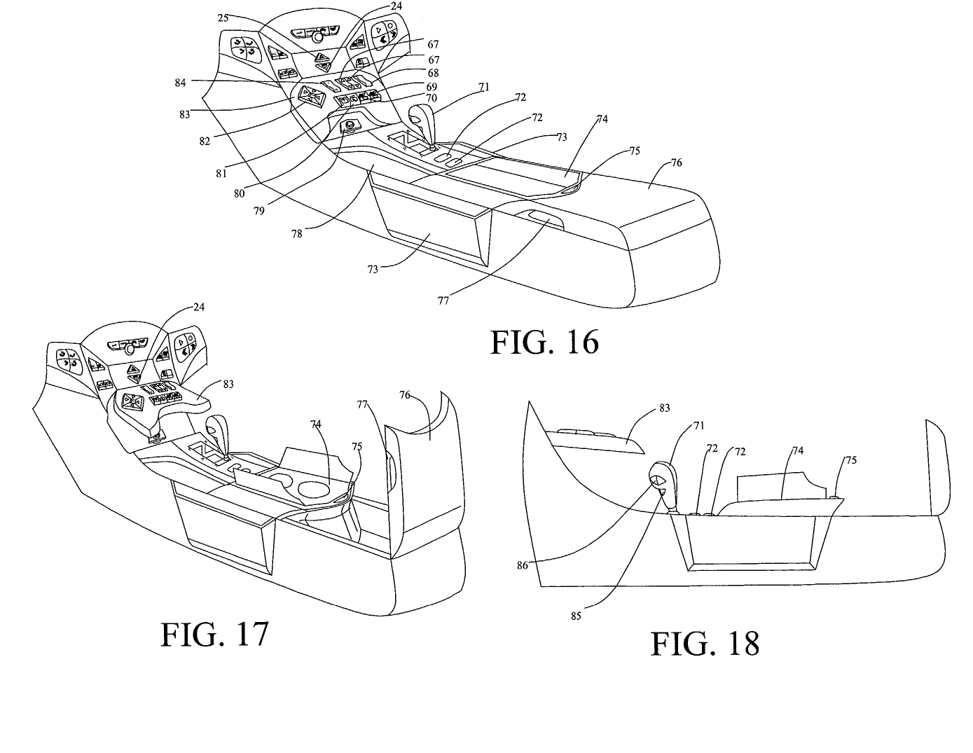

In FIG. 16, the extended center console is shown, which houses the movable pad 83, automatic transmission gear 71, cup holders 74 (which are concealed in this diagram), center console box 76, map storage cases 73 and mobile phone case 78. The hazard button 25 is located directly above the movable pad release button 24. This button 24 moves the pad 83 to a horizontal position when depressed once, and it returns the pad to its storage position when pressed a second time. Several buttons are located on the movable pad 83. The hexagonal button 82 is divided into two parts. The left buttons are for lowering or raising the driver's window, while the right buttons are for operating the front passenger's window. The ‘L/UL’ button 84 is for locking and unlocking all the doors of the vehicle.

The rear windows are operated using the two buttons 67. An extra button 68 is provided for any optional feature. The rear window washer button 81 is located beside the rear window wiper button 80. The driver's heated seat switch 70 and the front passenger's heated seat switch 69 are also located on the movable pad 83. The cigarette lighter 79 is located beneath the movable pad 83. Two extra buttons 72 can be placed behind the automatic gear 71. The cup holders 74 are concealed and the center console box 76 is closed.

In FIG. 17, the movable pad release button 24 has been depressed, and thus the movable pad 83 is at a horizontal position. The pad 83 can carry out its functions at either position. The cup holder release button 75 has been depressed, thus revealing the cup holders 74. The center console box has two handles 77, one on either side (only the left one is visible in this perspective view). The console box 76 is shown opened.

In FIG. 18, the movable pad 83 is shown while in its horizontal position. On the automatic gear 71, the overdrive button 85 (for driving on level terrain) and the selector button 86 (for shifting the vehicle to the desired gear position) are both shown. The two sides of the selector button 86 do not function separately. When depressed, the entire selector button 86 permits the gear position of the vehicle to be changed. The extra buttons 72, cup holder release button 75 and cup holders 74 are all shown in this side view.

In FIG. 19, the central console area is shown along with several buttons for operating the audio system. Depressing the volume button 26 turns on the audio system. The desired radio band is then selected using the FM button 40 or AM button 41. The tuning buttons, 87 and 88 are used to find the desired station. When it has been obtained, the program button 38 is then depressed, and the station can be saved on any of the station select buttons 19 (there are four station select buttons 19, which also have other functions described in FIG. 4). The bass button 90 when tilted upwards, increases the bass level. When tilted downwards, it decreases the bass level. The treble button 89 operates in a similar manner. It can be tilted upwards or downwards. Excessive pressure is not required to make these changes using the bass 90 or treble controls 89. The C.D. indicator light 91 is activated when a disc has been inserted into the C.D. player 17. The controls 42 for the C.D. player 17 are very basic.

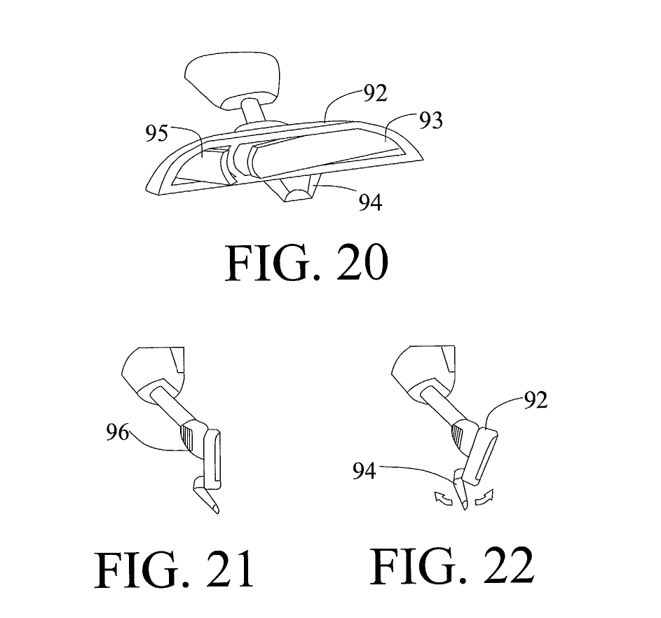

In FIG. 20, the inside rear view mirror 92 is shown. The mirror is divided into two parts. The left part 95 and the right part 93 can both be tilted independently to aid in viewing images that appear within the driver's blind spot.

In FIG. 21, a special flexible material 96 is shown, which enables the entire mirror to remain set once moved to a desired position.

As shown in FIG. 22, the adjusting knob 94 is used to tilt the entire mirror 92 back and forth.

While various forms and features have been described, it will be appreciated that the invention is not limited to these designs, but encompasses all variations falling within the scope of the appended claims.

What is claimed is:

1. An automotive cockpit with several integrated features and attached components, and also comprising of the driver's panel section.

2. An automotive cockpit in accordance with claim 1, comprising the combination of:
A modified steering wheel, flattened at the top and bottom areas;
An arrangement for the cruise control buttons placed on the left and right sides of the steering wheel;
A horn located at the center of the steering wheel;
Two ignitions, one on the left and the other on the right side of the steering wheel;
A modified knob, which controls the windshield wiper and washer;
A parking brake release lever for disengaging the parking brake;
The top meter display, which shows the vehicle speed;
The left meter display, which houses the fuel gauge and engine coolant temperature gauge;
The central meter display, which houses most of the warning and indicator lights;
A side ventilator located directly to the left of the windshield wiper knob;
A parking brake release lever, located directly beneath the coin box;
A coin box operated by a magnetic mechanism, which is disengaged by pushing box inwards gently, and is engaged by pushing the now extended coin box back to a closed position.

3. An automotive cockpit in which the central display is of a single construction with the entire instrument panel.

4. An automotive cockpit in accordance with claim 3 comprising the combination of:
A G.P.S. (global positioning system) screen placed on the top of the central display for viewing maps and other navigation data;
A combination of buttons placed around the G.PS. screen for controlling the information displayed;
A central display that houses the central ventilator;
A central display that houses the A.C./heating dials, and all switches for moderating the vehicles internal temperature;
A central display that houses the C.D. player and the FM/AM stereo system;
A central display that houses the modified turn signal buttons;
A central display that houses the instrument brightness control dial, directly beside the turn signal buttons;
A central display that houses the modified headlight buttons and high beam button;
A central display that houses the movable pad, from which the power windows and door locks of the vehicle can all be operated;
A central display housing button clusters for operating the C.D. player, radio, airflow control buttons, heater and air conditioner controls, trunk, hood, fuel filler lid release buttons and the clock;
A central display that houses all the buttons described and incorporated for the driver and front passenger's comfort;
A central display that houses one cigarette lighter;
A central display that houses the cup holders, which are observed when the cup holders release button is pressed.

5. An automotive cockpit in which the extended central console area is of a single construction with the entire instrument panel.

6. An automotive cockpit in accordance with claim 5, comprising the combination of:
A small case for placing a cell phone;
An automatic transmission gear for shifting the vehicle between the required gear positions;
A center console box, which can be lifted open by the handles on either side, in order to store small items;
Two map storages cases, placed on each side of the extended central console area.

7. An automotive cockpit in accordance with claim 1, housing the front passenger panel section, which comprises the combination of:
An airbag mounted above the extending board;
An extending board used to provide support for reading or writing, and located directly above the glove box;
Two penholders located on the extending board;
A side ventilator located towards the right side of the extending board.

8. An automotive cockpit in accordance with claim 1 which houses an inside mirror that has been divided into two parts, which can each be tilted to eliminate rear blind spots.
